(19) United States
(12) Patent Application Publication
(10) Pub. No.: US 2009/0239575 A1
(43) Pub. Date: Sep. 24, 2009

(54) METHODS FOR PROCESSING APPARATUS ORIGINATED COMMUNICATION REQUEST, HANDLING EQUIPMENT IDENTITY REQUESTS AND COMMUNICATION APPARATUSES UTILIZING THE SAME

(75) Inventor: Shih Wen FU, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/234,025

(22) Filed: Sep. 19, 2008

Related U.S. Application Data
(60) Provisional application No. 61/038,426, filed on Mar. 21, 2008.
(60) Provisional application No. 61/047,143, filed on Apr. 23, 2008.

(51) Int. Cl. H04M 1/00; H04Q 7/20

(52) U.S. Cl. 455/552.1; 455/422.1

(57) ABSTRACT

A communication apparatus is provided. A first subscriber identity card camps on a first cell belonging to a first wireless network via at least one radio transceiver module. A second subscriber identity card camps on a second cell belonging to a second wireless network via the radio transceiver module. A memory device stores a plurality of phonebook entries each comprising a destination address and information indicating one of the first and second subscriber identity cards as a preferred subscriber identity card for the destination address. A processor receives an apparatus originated communication request with a first destination address, determines the preferred subscriber identity card for the received first destination address by inspecting the phonebook entries, and establishes a wireless communication with a peer device with the received first destination address through one of the first cell and the second cells in response to the determined preferred subscriber identity card.

### CROSS REFERENCE TO RELATED APPLICATIONS

The application claims the benefit of U.S. Provisional Application No. 61/038,426 filed 2008/03/21 and entitled “Systems and methods for handling mobile originated (MO) and mobile terminated (MT) calls with dual (U)SIM cards”, and U.S. Provisional Application No. 61/047,143 filed 2008/04/23 and entitled “Systems and methods for handling operations related to two (U)SIM cards”. The entire contents of which are hereby incorporated by reference.

### BACKGROUND OF THE INVENTION

1. Field of the Invention

The invention relates to methods for processing an apparatus originated communication request and handling the equipment identity requests in a communication apparatus, and more particularly to a method for processing an apparatus originated communication request and handling the equipment identity requests with the considerations of user preference and service reliability.

2. Description of the Related Art

The term “wireless”, normally refers to an electrical or electronic operation, which is accomplished without the use of a “hard wired” connection. “Wireless communication”, is the transfer of information over a distance without the use of electrical conductors or wires. The distances involved may be short (a few meters for television remote controls) or very long (thousands or even millions of kilometers for radio communications). The best known example of wireless communication is the cellular telephone. Cellular telephones use radio waves to enable an operator to make phone calls to another party, from many locations world-wide. They can be used anywhere, as long as there is a cellular telephone site to house equipment that can transmit and receive signals, which are processed to transfer both voice and data to and from the cellular telephones.

There are various well-developed and -defined cellular communication technologies. For example, the Global System for Mobile communications (GSM) is a well-defined and commonly adopted communications system, which uses time division multiple access (TDMA) technology, which is a multiplex access scheme for digital radio, to send voice, data, and signalling data (such as a dialed telephone number) between mobile phones and cell sites. The CDMA2000 is a hybrid mobile communications 2.5G/3G (generation) technology standard, that uses code division multiple access (CDMA) technology. The UMTS (Universal Mobile Telecommunications System) is a 3G mobile communications system, which provides an enhanced range of multimedia services over the 2G GSM system. The Wireless Fidelity (Wi-Fi) is a technology defined by the 802.11b engineering standard and can be used for home networks, mobile phones, video games, to provide a high-frequency wireless local area network.

With the advanced development of wireless communication technologies, it is now possible to provide multiple wireless communication services using different or the same communication technologies in one mobile station (MS). In order to provide an efficient interface and reliable services, methods for handling an apparatus originated communication request and equipment identity requests are provided.

### BRIEF SUMMARY OF THE INVENTION

Communication apparatuses and methods for scheduling a receiving process in a communication apparatus are provided. An embodiment of such a communication apparatus comprises at least one radio transceiver module, a first subscriber identity card, a second subscriber identity card, a memory device and a processor. The first subscriber identity card camps on a first cell belonging to a first wireless network via at least one radio transceiver module. The second subscriber identity card camps on a second cell belonging to a second wireless network via the radio transceiver module. The memory device stores a plurality of phonebook entries each comprising a destination address and information indicating one of the first and second subscriber identity cards as a preferred subscriber identity card for the destination address. The processor receives an apparatus originated communication request with a first destination address, determines the preferred subscriber identity card for the received first destination address by inspecting the phonebook entries, and establishes a wireless communication with a peer device with the received first destination address through one of the first cell and the second cells in response to the determined preferred subscriber identity card.

An embodiment of a method for processing an apparatus originated communication request of a communication apparatus is provided. The communication apparatus comprises at least one radio transceiver module, a first subscriber identity card camping on a first cell belonging to a first wireless network via the radio transceiver module. The communication apparatus also comprises a second subscriber identity card camping on a second cell belonging to a second wireless network via the radio transceiver module, a memory device storing a plurality of phonebook entries each comprising an address and information indicating one of the first and second subscriber identity cards as a preferred subscriber identity card for the address, and at least one processor coupled to the first subscriber identity card, the second subscriber identity card, the memory device and the radio transceiver module for controlling the operation thereof. The method comprises: receiving an apparatus originated communication request with a destination address; determining whether an identity of the preferred subscriber identity card for the destination address has been stored in one of the phonebook entries; and establishing a wireless communication with a peer device with the destination address through one of the first or second cell that the preferred subscriber identity card camps on when the identity of the preferred subscriber identity card for the destination address has been stored.

Another embodiment of a communication apparatus comprises a single radio transceiver module, a first socket, a second socket, a first subscriber identity card, a second subscriber identity card, a memory device and a processor. The first subscriber identity card is inserted into the first socket and camps on a first cell belonging to a first wireless network via the radio transceiver module. The second subscriber identity card is inserted into the second socket and camps on a second cell belonging to a second wireless network via the radio transceiver module. The memory device stores a first equipment identity for the first socket and a second equipment identity for the second socket. The processor is coupled to the first subscriber identity card, the second subscriber identity card, the memory device, and the radio transceiver module, receives an equipment identity request message via the radio transceiver module, determines whether the equipment identity request message is sent from the first cell or the second cell, responds with the first equipment identity via the radio transceiver module when the equipment identity request message is sent from the first cell, and responds with the second equipment identity via the radio transceiver module when the equipment identity request message is sent from the second cell.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a communication apparatus according to an embodiment of the invention;

FIG. 2 shows a communication apparatus according to another embodiment of the invention;

FIG. 3 shows a communication apparatus according to another embodiment of the invention;

FIG. 4 shows an exemplary network topology according to an embodiment of the invention;

FIG. 5 shows logical channel assignments and signaling procedures of an apparatus originated request in the GSM;

FIG. 6 shows a data structure for a phonebook entry according to an embodiment of the invention;

FIG. 7 shows a data structure of contact lists according to an embodiment of the invention;

FIG. 8 shows a flow chart, facilitated by the MMI, for inputting the corresponding fields of a phonebook entry according to an embodiment of the invention;

FIG. 9 shows a flow chart of a method for processing an apparatus originated communication request of a communication apparatus according to an embodiment of the invention;

FIG. 10 shows a front side of the communication apparatus according to an embodiment of the invention;

FIG. 11 shows a back side of the communication apparatus according to an embodiment of the invention;

FIG. 12 shows a flow chart of a method for processing an apparatus originated communication request of a communication apparatus according to another embodiment of the invention;

FIG. 13 shows a flow chart of a method for processing an apparatus originated communication request of a communication apparatus according to another embodiment of the invention;

FIG. 14 shows a flow chart of the method for updating the corresponding field of phonebook entry according to an embodiment of the invention;

FIG. 15 shows a flow chart of providing the IMEIs for the communication apparatus according to an embodiment of the invention

FIG. 16 shows a sequence diagram illustrating an identification procedure according to an embodiment of the invention; and

FIG. 17 shows a flow chart of the method for handling the equipment identity requests in the identification procedure according to an embodiment of the invention.

### DETAILED DESCRIPTION OF THE INVENTION

The following description is of the best-contemplated mode of carrying out the invention. The description is made for the purpose of illustrating the general principles of the invention and should not be taken in a limiting sense. The scope of the invention is best determined by reference to the appended claims.

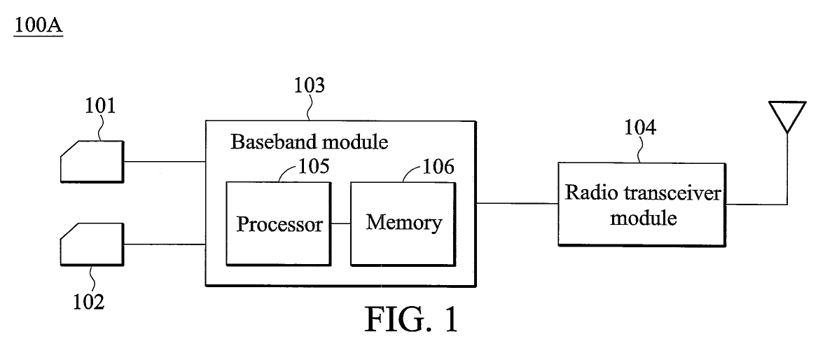

FIG. 1 shows a communication apparatus capable of processing an apparatus originated communication request, also referred to as mobile originated (MO) call request, and handling the equipment identity requests according to an embodiment of the invention. As shown in FIG. 1, communication apparatus 100A comprises subscriber identity cards 101 and 102, a baseband module 103, and a radio transceiver module 104, wherein the baseband module 103 is coupled to the subscriber identity cards 101 and 102, and the radio transceiver module 104. The radio transceiver module 104 receives wireless radio frequency signals, converts the received signals to baseband signals to be processed by the baseband module 103, or receives baseband signals from the baseband module 103 and converts the received signals to wireless radio frequency signals to be transmitted to a peer device. The radio transceiver module 104 may comprise a plurality of hardware devices to perform radio frequency conversion. For example, the radio transceiver module 104 may comprise a mixer to multiply the baseband signals with a carrier oscillated in the radio frequency of the wireless communication system, wherein the radio frequency may be, for example, 900 MHz or 1800 MHz for a global system for mobile communication (GSM), or 1900 MHz for a Universal Mobile Telecommunications System (UMTS). The baseband module 103 further converts the baseband signals to a plurality of digital signals, and processes the digital signals, and vice versa. The baseband module 103 may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on. The baseband module 103 further comprises a memory device 106 and a processor 105 for controlling the operations of the baseband module 103, the radio transceiver module 104, and the subscriber identity cards 101 and 102 plugged into two sockets, respectively. The processor 105 reads data from the plugged subscriber identity cards 101 and 102 and writes data to the plugged subscriber identity cards 101 and 102. It is to be noted that the memory device 106 may also be configured outside of the baseband module 103 and the invention should not be limited thereto.

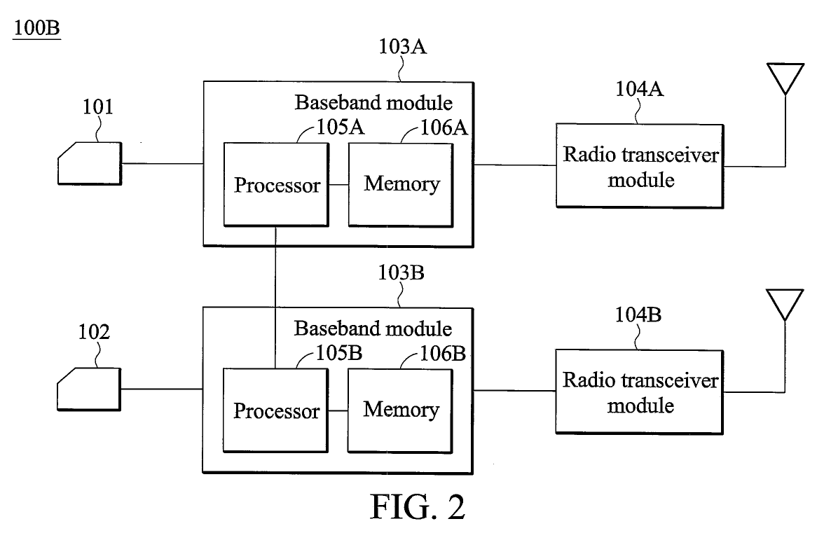

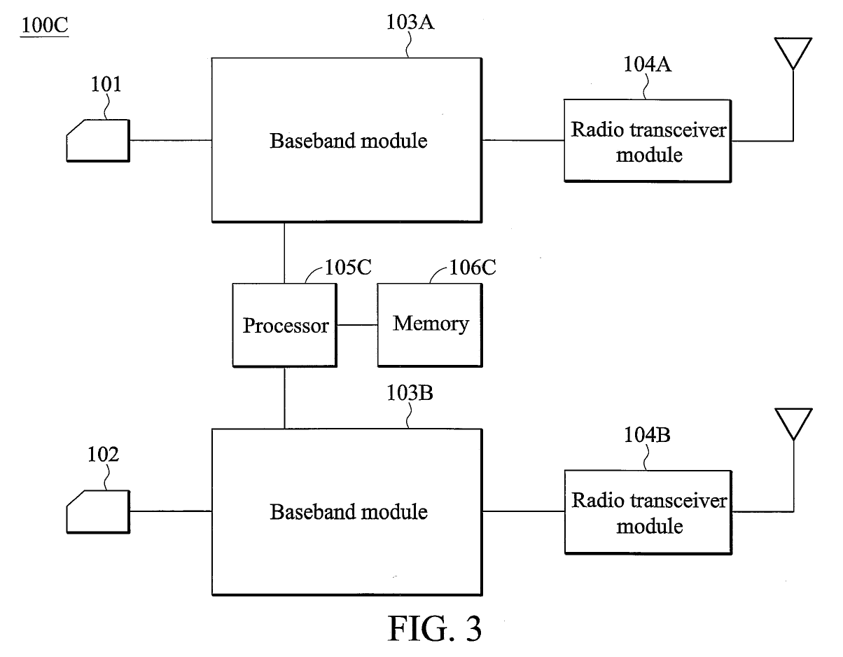

According to another embodiment of the invention, the communication apparatus comprising more than one subscriber identity card, may also comprise more than one baseband module and radio transceiver module, respectively, for each subscriber identity card. FIG. 2 and FIG. 3 respectively show communication apparatuses according to another embodiments of the invention. As shown in FIG. 2 and FIG. 3, communication apparatus 100B comprises subscriber identity cards 101 and 102, baseband modules 103A and 103B, and radio transceiver modules 104A and 104B, wherein the baseband module 103A is coupled to the subscriber identity card 101 and the radio transceiver module 104A, and the baseband module 103B is coupled to the subscriber identity card 102 and the radio transceiver module 104B. The operations of the baseband modules 103A and 103B are similar with that of the baseband module 103 and are not illustrated here for brevity. Similarly, the operations of the radio transceiver module 104A and 104B are similar with that of the radio transceiver module 104 and are not illustrated here for brevity. It is noted that in FIG. 2, the baseband module 103A comprises a memory device 106A and a processor 105A for controlling the operations of the subscriber identity card 101, the baseband module 103A and the radio transceiver module 104A, and the baseband module 103B also comprises a memory device 106B and a processor 105B for controlling the operations of the subscriber identity card 102, the baseband module 103B and the radio transceiver module 104B. The processors 105A and 105B may be coupled and communicate with each other. The data stored in memory devices 106A and 106B may be shared and accessed by both of the processors 105A and 105B. For example, one of the processor may be a master processor and the other one may be a slave processor to cooperate with the master processor. As shown in FIG. 3, according to still another embodiment of the invention, the communication apparatus 100C may comprise one memory device 106C and one processor 105C for controlling the operations of the subscriber identity cards 101 and 102, the baseband modules 103A and 103B, and the radio transceiver modules 104A and 104B. The operations of the processor 105C are similar with that of the processor 105 and are not illustrated here for brevity. The described processors 105, 105A, 105B and 105C may be general-purposed processors and when executing program code perform the mentioned control operations. The described memory 106, 106A, 106B and 106C may comprise at least one of read only memory (ROM), random access memory (RAM), NOR flash and NAND flash for storing program code and data.

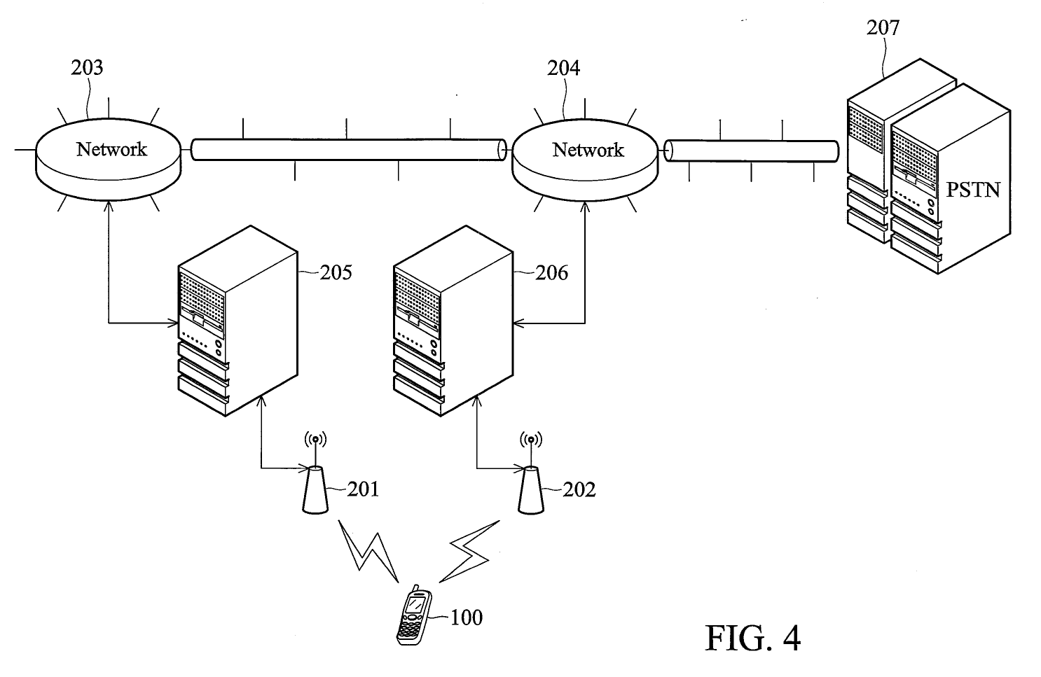

FIG. 4 shows an exemplary network topology according to an embodiment of the invention. The communication apparatus 100 shown in FIG. 4, may be the communication apparatuses 100A, 100B and 100C previously described in FIG. 1 to FIG. 3. Thus, from hereinafter, the communication apparatus 100 will be used to represent all like previously described apparatuses for brevity. The communication apparatus 100, equipped with more than one subscriber identity card, may simultaneously access more than one network 203 and 204 of the same or different communication technologies, where the network 203 or 204 may be the GSM, WCDMA, Wi-Fi, CDMA2000 or Time Division-Synchronous Code Division Multiple Access (TD-SCDMA) network, or Internet, or the like, after camping on or associating with the cells managed by access stations 201 and 202, where the access station 201 or 202 may be a base station, a node-B, an access point compatible with 802.1a, 802.1b or 802.1g. The communication apparatus 100 may issue an apparatus originated communication request, such as a voice call, a data call, a video call, or a voice over Internet Protocol (VOIP) call, to a called party (i.e. the corresponding peer of another wired or wireless communication apparatus) through at least one of the networks 203 and 204 with corresponding intermediary apparatuses 205 and 206 (for example, the GSM network with a Mobile Switching Center (MSC), the WCDMA/TD-SCDMA network with a Radio Network Controller (RNC), or the Internet with a Session Initiation Protocol (SIP) server), or through the Public Switched Telephone Network (PSTN) 207 or any combinations thereof, by using any of the equipped subscriber identity cards. Moreover, the communication apparatus 100 may receive an apparatus terminated communication request, also referred to as mobile terminated (MT) call request, such as an incoming phone call, with any of the subscriber identity cards from a calling party. It is to be understood that there may be one or more gateways positioned between heterogeneous types of networks.

According to an embodiment of the invention, the subscriber identity cards 101 and 102 may relate to one type of wireless communication system. For example, the subscriber identity card 101 or 102 may be the subscriber identity module (SIM) card corresponding to the GSM, or the universal subscriber identity module (USIM) card corresponding to the UMTS, or the removable user identity module (RUIM) card or the CDMA Subscriber Identity Module (CSIM) card corresponding to the CDMA2000 communication system, or others. An SIM card typically contains user account information, an international mobile subscriber identity (IMSI) and a set of SIM application toolkit (SAT) commands and provides storage space for phone book contacts. The processor, such as 105, 105A, 105B or 105C, of the baseband module, such as 103, 103A or 103B, may interact with a micro control unit (MCU) of the SIM card to fetch data or SAT commands from the plugged SIM card. The communication apparatus 100 is immediately programmed after being plugged into the SIM card. The SIM card may also be programmed to display custom menus for personalized services. The communication apparatus 100 may be plugged into an USIM card for UMTS (also called 3G) telephony communication. The USIM card stores user account information, IMSI, authentication information and a set of USIM Application Toolkit (USAT) commands and provides storage space for text messages and phone book contacts. The baseband processor 105, 105A, 105B or 105C may interact with an MCU of the USIM card to fetch data or SAT commands from the plugged USIM card. The phone book on the USIM card is more enhanced than that on the SIM card. For authentication purposes, the USIM card may store a long-term preshared secret key K, which is shared with the Authentication Center (AuC) in the network. The USIM MCU may verify a sequence number, that may be within a range, by using a window mechanism to avoid replay attacks, and generates the session keys CK and IK to be used in the confidentiality and integrity algorithms of the KASUMI (also termed A5/3) block cipher in the UMTS. The communication apparatus 100 is immediately programmed after being plugged into the USIM card. The IMSI is a unique number associated with a global system for mobile communication (GSM) or a universal mobile telecommunications system (UMTS) network user. The IMSI may be sent by the communication apparatus 100 to the GSM or UMTS network to acquire other details of the mobile user in the Home Location Register (HLR) or, as locally copied, in the Visitor Location Register (VLR). An IMSI is typically 15 digits long, but can be shorter. The first 3 digits are the Mobile Country Code (MCC), and the following digits, are the Mobile Network Code (MNC), which are either 2 digits (European standard) or 3 digits (North American standard). The remaining digits are the mobile subscriber identification number (MSIN) for the GSM or UMTS network user.

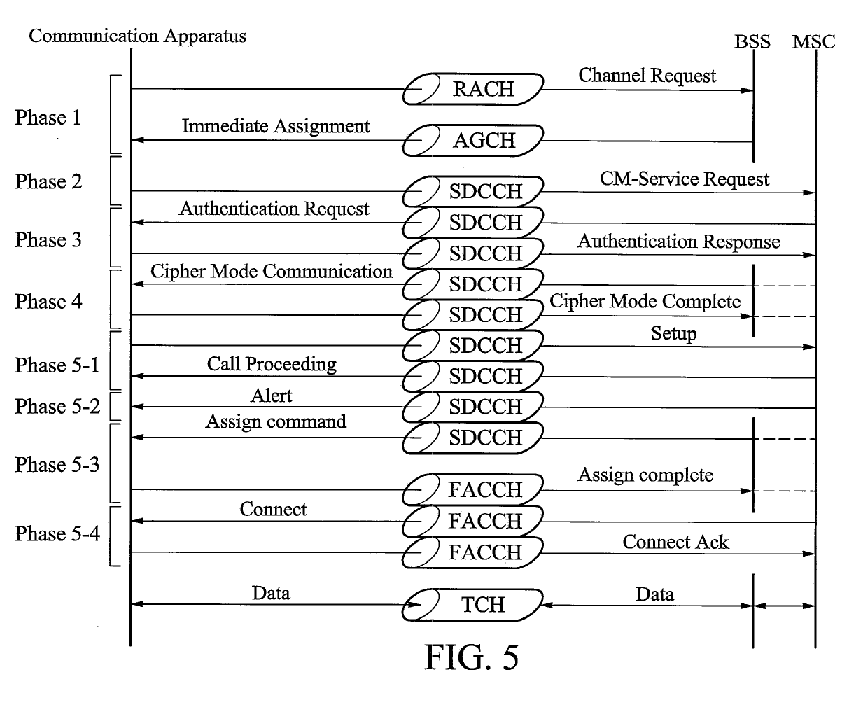

FIG. 5 shows logical channel assignments and signaling procedures of an apparatus originated communication request in GSM. In the GSM, a Call Control (CC), comprises procedures to establish, control, and terminate a communication service, and is an element of Connection Management (CM). When the communication apparatus 100 plans to originate a communication service, such as a voice call service, the CC entity first requests a Mobility Management (MM) connection from the local MM entity (Phase 1) via a Random Access Channel (RACH). For a standard call, the communication apparatus 100 may need to register with the wireless network, whereas for an emergency call, registration is only optionally required. That is, an emergency call may be established on an unenciphered Radio Resource (RR) connection from a communication apparatus 100 that has not registered with the wireless network. The base station system (BSS) in the wireless network may assign a Stand-alone Dedicated Control Channel (SDCCH) or a Traffic Channel (TCH) via an Immediate Assignment carried in the Access Grant Channel (AGCH). After the process of sending out a CM-service request (Phase 2), authentication (Phase 3) and ciphering (Phase 4) with the MSC via the SDDCH is completed, an MM connection is established. After successful establishment of the MM connection and activation of the user data encryption, the service-requesting CC entity is informed. Thus, the signals on the connection desire to connect to the CC entity in the Mobile Switching Center MSC (SETUP). The MSC may respond to the connection request in several ways. The MSC may indicate with a message Call Proceeding (Phase 5-1) that the call request has been accepted and that all the necessary information for the setup of the call is available. Otherwise, the call request may be declined with a message Release Complete. Next, the communication apparatus 100 receives the Alert message (Phase 5-2) when the MSC is trying to connect to the called party. As soon as the called party receives the Alert message and accepts the call, the communication apparatus 100 receives an Assign Command and a dedicated channel will be assigned after the communication apparatus 100 responds to an Assignment Complete message via a Fast Associated Control Channel (FACCH) (Phase 5-3). The communication apparatus 100 next responds with a Connect Acknowledge message after receiving the Connect message from the MSC (Phase 5-4), and the traffic channel, successfully established on the TCH and the communication apparatus 100, may now begin to communicate with the called party. It is to be noted that the CC procedure of the WCDMA or TD-SCDMA system is similar to that of GSM system and is not further described for brevity.

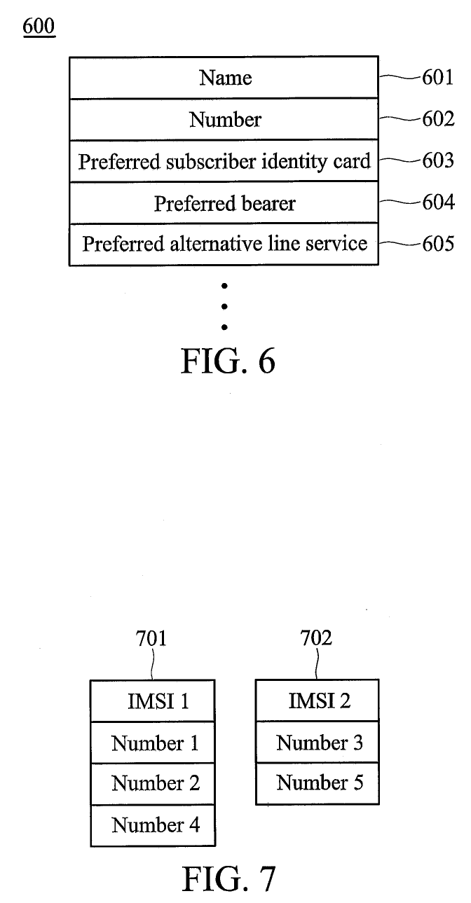

According to a first embodiment of the invention, the methods for processing an apparatus originated communication request in a communication apparatus, such as the communication apparatus 100A, 100B or 100C previously described and the communication apparatus 100, used hereinafter to represent all like previously described apparatuses for brevity, will be illustrated in the following. In the communication apparatus 100, a memory device such as the memory device 106, 106A, 106B or 106C previously described, may store a plurality of phonebook entries. Each phonebook entry may comprises a contact name, a destination address, identities for a preferred subscriber identity card, a preferred bearer and a preferred alternative line service, and the similar. The memory device 106, 106A, 106B or 106C in the communication apparatus 100 may be a non-volatile memory device that will store data even when the communication apparatus 100 is powered off. FIG. 6 shows a data structure for a phonebook entry 600 according to the first embodiment of the invention, where the phonebook entry 600 may be stored in the memory device such as the 106, 106A, 106B or 106C previously described. The Name field 601 may be used to store a contact name for another peer user. The Number field 602 may be used to store the destination address of the peer user. The destination address may be a series of predetermined numbers directed to the peer user, such as an IP address for a VOIP call or a phone number of another wired or wireless communication apparatus for a circuit switch call, or others. The preferred subscriber identity card field 603 may be used to store an identity regarding a preferred subscriber identity card that the user prefers to use when originating a connection with the peer user. Since as shown in FIG. 1 to FIG. 3, with the communication apparatus 100A, 100B or 100C comprising more than one subscriber identity card, the communication apparatus user may select a preferred subscriber identity card for a peer user and store the selection in the preferred subscriber identity card field 603, so as to use the preferred subscriber identity card when the user plans to originate a connection with the peer user. According to the embodiment, since each subscriber identity card comprises a unique identity, such as the IMSI previously described, the preferred subscriber identity card field 603 may store the identity of the selected subscriber identity card to distinguish from the other subscriber identity cards.

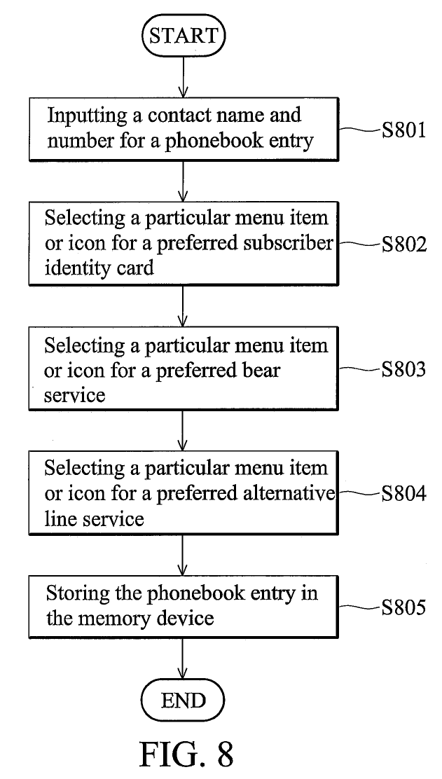

The preferred bearer field 604 may be used to store a preferred bearer service that the user prefers to use when originating a connection with the peer user. The bearer represents an information transmission path, such as a voice call, a data call, a VOIP call, a video call, or others. The user may select an identity regarding a preferred bearer service and store the selection in the preferred bearer field 604 so as to use the preferred bearer when the user plans to originate a connection with the peer user. The preferred alternative line service field 605 may be used to store an identity regarding a preferred Alternate Line Service (ALS) that the user prefers to use when originating a connection with the peer user. It is to be understood that ALS provides the communication apparatus 100 with the capability of associating two alternate lines with one IMSI. A user will be able to make and receive calls on either line as desired and will be billed separately for calls on each line. Each line will be associated with a separate directory number (MSISDN) and separate subscription profile. The information stored in the phonebook entries may be input by a user via a man-machine interface (MMI). FIG. 8 shows a flow chart, facilitated by the MMI, for inputting the fields of a phonebook entry according to the first embodiment of the invention. The MMI may comprise screen menus and icons, command language and online help displayed on a display of the communication apparatus 100, with well as at least one input device of a touch panel, physical keys on a key pad, buttons, dragging jogs and the similar. By using input devices of the MMI, users may manually touch, press, click, rotate or move the input devices to operate the communication apparatus 100. Facilitated by the MMI, the user first inputs a contact name and a number for a phonebook entry (Step S801). Next, the user selects a particular menu item or icon representing a preferred subscriber identity card (Step S802), a relevant menu item or icon representing a preferred bear service (Step S803), and a specific menu item or icon representing a preferred alternative line service (Step S804) for the input contact name and number. Finally, the input data and selections are stored in relevant fields of a phonebook entry of the memory device (Step S805). It is to be understood that the user may not decide at least one for a preferred subscriber identity card, a preferred bear service and a preferred ALS, and null data or a particular code is stored in corresponding field of the entry.

Alternatively, when recording the identity of preferred subscriber identity card for each phonebook entry, the memory device of the communication apparatus 100, such as the 106, 106A, 106B or 106C previously described, or one of the subscriber identity cards 101 and 102 may store and maintain a contact list (or number list) for each subscriber identity card. FIG. 7 shows a data structure of the contact lists according to the first embodiment of the invention. The contact lists 701 and 702, respectively record the contact numbers 1, 2 and 4 for the subscriber identity card 101 and the contact numbers 3 and 5 for the subscriber identity card 102. As described above, the identities of the subscriber identity cards 101 and 102, such as the IMSI 1 and IMSI 2, may be used to distinguish one contact list from another. If a contact number is present in the list for the subscriber identity card 101, it means that user would more likely to connect to a peer user with the contact number via the subscriber identity card 101 instead of the subscriber identity card 102.

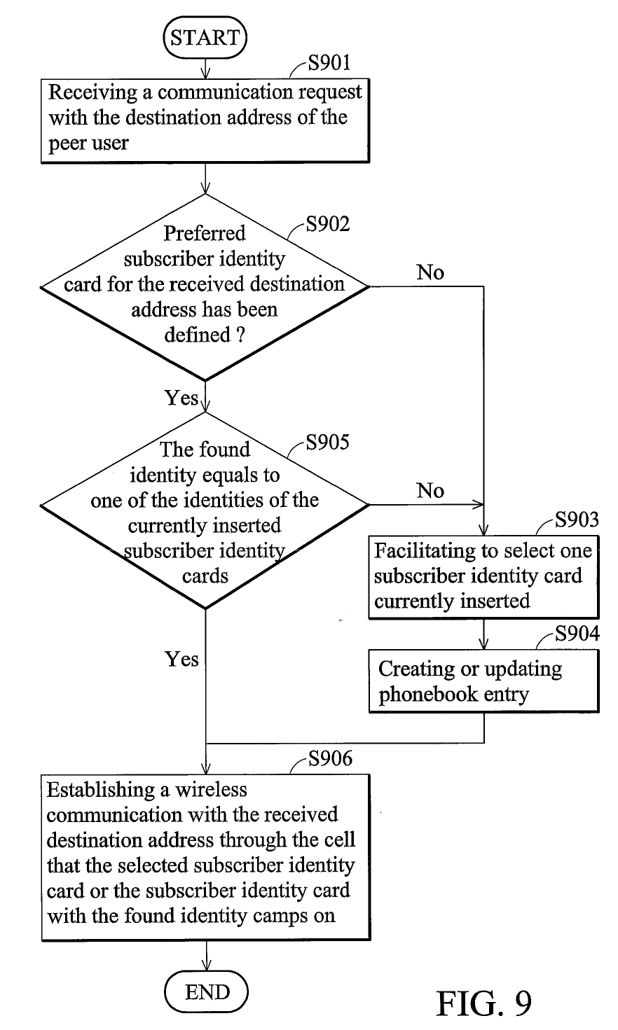

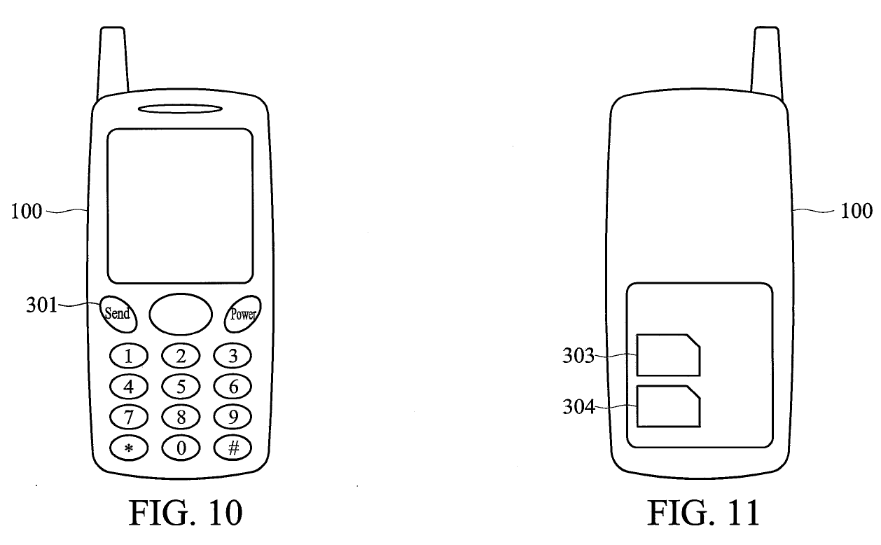

FIG. 9 shows a flow chart of a method for processing an apparatus originated communication request of a communication apparatus, such as the communication apparatus 100, 100A, 100B, or 100C previously described, according to the first embodiment of the invention. When a user plans to originate a communication service with another peer user, a contact name of the peer user or a specific number of a telephone or a mobile station held by the peer user is selected from a contact menu by the user via an MMI, or a specific number of a telephone or a mobile station held by the peer user is input by the user via an MMI. After the user presses a SEND key 301 as shown in FIG. 10, the communication request may be originated by either the subscriber identity card 101 or 102 according to the preference setting of the corresponding phonebook entry as shown in FIG. 6 or the contact lists as shown in FIG. 7. As shown in FIG. 9, the processor (e.g. the processor 105, 105A, 105B or 105C) receives the communication request with the destination address of the peer user (Step S901). Next, the processor determines whether a preferred subscriber identity card for the received destination address has been defined, more specifically, determines whether an identity representing a preferred subscriber identity card has been stored in a preferred subscriber identity card field (e.g. 603) of a phonebook entry corresponding to the received destination address of the peer user by inspecting the stored phonebook entries (Step S902). When the preferred identity has not been found, an MMI is activated by the processor so that the user may select one subscriber identity card currently inserted, such as those inserted into the sockets 303 and 304 as shown in FIG. 11 (Step S903). Next, the processor may facilitate the user to decide whether to create a new phonebook entry or update the existing preferred subscriber identity card field related to the received destination address via the MMI (Step S904). It is to be noted that step S904 may be optional. When the preferred identity has been found, the processor further determines whether the found identity equals to one of the identities of the currently inserted subscriber identity cards (Step S905), such as the IMSI of the subscriber identity card 101 or 102. When the found identity equals to one of the identities of the currently inserted subscriber identity cards, the processor establishes a wireless communication with a peer device of the destination address through a cell that the subscriber identity card with the found identity or that the selected subscriber identity card camps on (Step S906). When the found identity does not equal to any of the identities of the currently inserted subscriber identity cards, the processor activates an MMI so that the user may select one currently inserted subscriber identity card to be used (Step S903), and facilitate the user to decide whether to create a new phonebook entry or update the existing phonebook entry related to the received destination address in response to the selected subscriber identity card (Step S904). After the processor obtains a signal indicating the selected subscriber identity card, the processor establishes a wireless communication with the destination address through the corresponding cell by using the selected subscriber identity card (Step S906).

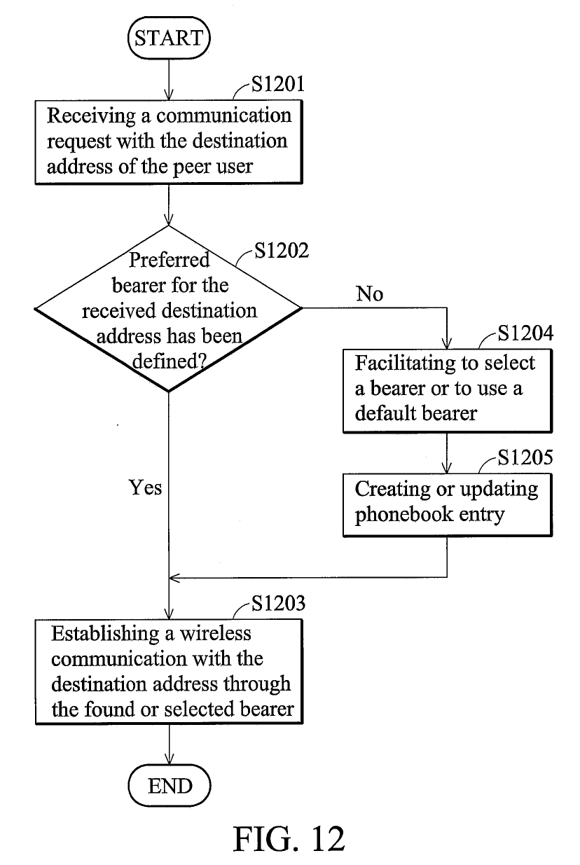

According to another embodiment of the invention, the apparatus originated communication service may be established through the preferred bearer previously selected by the user by inspecting the preferred bearer field of the corresponding phonebook entry. FIG. 12 shows a flow chart of a method for processing an apparatus originated communication request of a communication apparatus, such as 100, 100A, 10B, or 100C previously described, according to the another embodiment of the invention. When a user plans to originate a communication service with another peer user, a contact name of the peer user or a specific number of a telephone or a mobile station held by the peer user is selected from a contact menu by the user via an MMI, or a specific number of a telephone or a mobile station held by the peer user is input by the user via an MMI. After the user presses a SEND key 301 as shown in FIG. 10, the communication request may be originated through the preferred bearer according to the preferred bearer setting of the corresponding phonebook entry. As shown in FIG. 12, the processor (e.g. 105, 105A, 105B or 105C) receives the communication request with the destination address of the peer user (Step S1201). Next, the processor determines whether a preferred bearer for the received destination address has been defined, more specifically, determines whether a preferred bearer has been stored in the preferred bearer field (e.g. 604) of the phonebook entry corresponding to the received destination address of the peer user by inspecting the stored phonebook entries (Step S1202). When the preferred bearer has been found, the processor establishes a wireless communication with a peer device with the destination address through the preferred bearer (Step S1203). When the preferred bearer has not been found, an MMI is activated by the processor to allow the user to select a bearer or to use a default bearer (Step S1204). Next, the processor may facilitate the user to decide whether to create a new phonebook entry or update the existing preferred bearer field related to the received destination address with the selected bearer via the MMI (Step S1205). It is to be noted that step S1205 may be optional. After the processor obtains a signal indicating the selected bearer, the processor establishes a wireless communication with the destination address through the selected bearer (Step S1203).

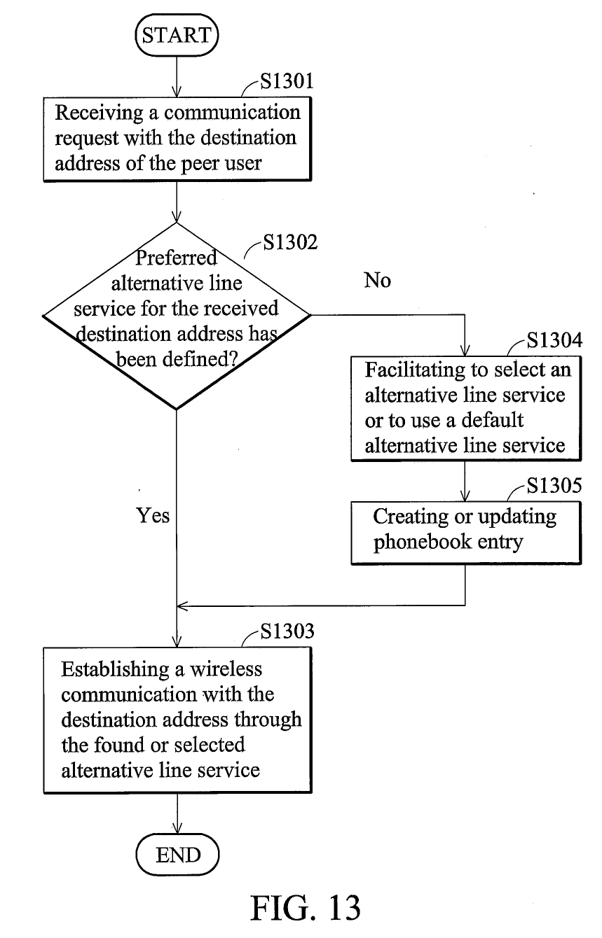

According to yet another embodiment of the invention, the apparatus originated communication service may be established through the preferred alternative line service previously selected by the user by inspecting the preferred alternative line service field of the corresponding phonebook entry. FIG. 13 shows a flow chart of a method for processing an apparatus originated communication request of a communication apparatus, such as 100, 100A, 100B, or 100C previously described, according to yet another embodiment of the invention. When a user plans to originate a communication service with another peer user, a contact name of the peer user or a specific number of a telephone or a mobile station held by the peer user is selected from a contact menu by the user via an MMI, or a specific number of a telephone or a mobile station held by the peer user is input by the user via an MMI. After the user presses a SEND key 301 as shown in FIG. 10, the communication request may be originated through the preferred alternative line service according to the preferred alternative line service setting of the corresponding phonebook entry. As shown in FIG. 13, the processor (e.g. 105, 105A, 105B or 105C) receives the communication request with the destination address of the peer user (Step S1301). Next, the processor determines whether a preferred alternative line service has been defined, more specifically, determines whether a preferred alternative line service has been stored in the preferred alternative line service field (e.g. 605) of the phonebook entry corresponding to the received destination address of the peer user by inspecting the stored phonebook entries (Step S1302). When the preferred alternative line service has been found, the processor establishes a wireless communication with a peer device with the destination address through the preferred alternative line service (Step S1303). When the preferred alternative line service has not been found, an MMI is activated by the processor to allow the user to select an alternative line service or to use a default alternative line service (Step S1304). Next, the processor may facilitate the user to decide whether to create a new phonebook entry or update the existing preferred alternative line service field related to the received destination address with the selected alternative line service via the MMI (Step S1305). It is to be noted that step S1305 may be optional. After the processor obtains a signal indicating the selected alternative line service, the processor establishes a wireless communication with the destination address through the selected alternative line service (Step S1303).

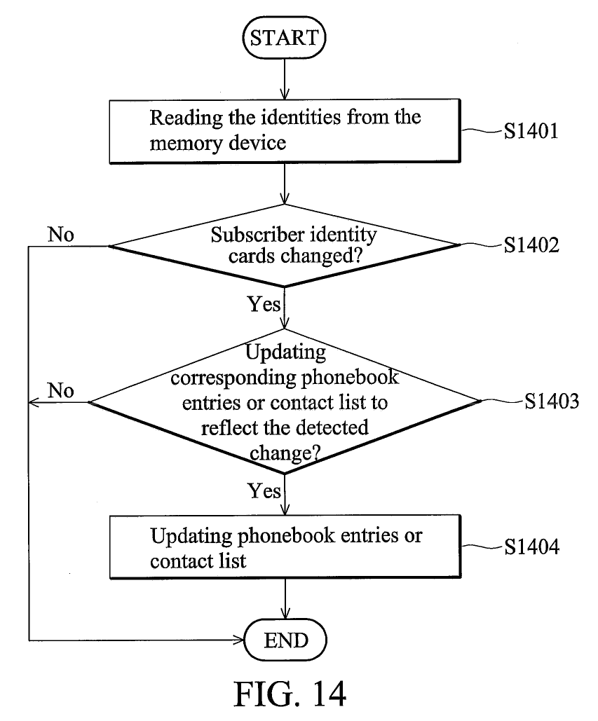

According to yet another embodiment of the invention, the memory device, such as the 106, 106A, 106B or 106C, may further store a plurality of identities of the previously inserted subscriber identity cards at a moment, for example, at a moment after a previous power-on, wherein the subscriber identity cards, such as 101 and 102, may be respectively inserted into the sockets 303 and 304 as shown in FIG. 11. It is to be understood that the identities of the previously inserted subscriber identity cards are stored in a non-volatile region of the memory device. Since any of the subscriber identity cards may be replaced by the user, the processor may further detect whether the subscriber identity cards have been changed, by comparing the identities stored in the memory device with the identities of the subscriber identity cards currently inserted into the sockets 303 and 304, and then correspondingly decide whether to update the content of the phonebook entries. According the embodiment of the invention, the detection may be implemented after the communication apparatus 100 is powered on and the recorded identities may be the IMSI or the Integrated Circuit Card Identity (ICCID) of the subscriber identity cards. FIG. 14 shows a flow chart of the method for updating the phonebook entries according to the embodiment of the invention. First, the processor (e.g. 105, 105A, 105B or 105C) reads the identities of the previously inserted subscriber identity cards from the memory device (Step S1401). Next, the processor determines whether at least one of the subscriber identity cards have been changed by comparing the read identities with the identities of the currently inserted subscriber identity cards (Step S1402). When the processor detects that any previous subscriber identity card is changed, or there is a subscriber identity card newly inserted, the processor further activates an MMI to allow the user to decide whether to update corresponding phonebook entries or contact list related to the subscriber identity card that are now removed to reflect the detected change (Step S1403). For example, the processor detects the change when the an IMSI of the memory device is found in one of the inserted subscriber identity card and another IMSI of the memory device is not found in all inserted subscriber identity cards, and determines that the a subscriber identity card containing the not found IMSI has been replaced with another subscriber identity card whose IMSI is not recorded in the memory device. When the user decides to update, the processor updates all preferred subscriber identity card fields (e.g. 603) recording an identity corresponding to the removed subscriber identity card to replace with another identity corresponding to the newly inserted subscriber identity card or updates a contact list (e.g. 701 or 702) containing an identity of the removed subscriber identity card to replace with another identity of newly inserted subscriber identity card (Step S1404). It is to be understood that after the detection shown in FIG. 14 the memory device is updated to store identities of currently inserted subscriber identity cards.

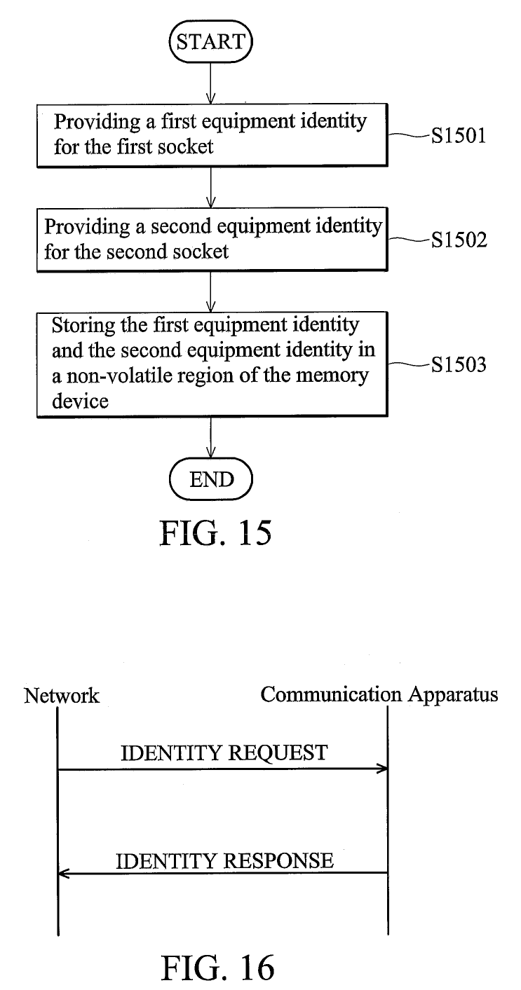

According to a second embodiment of the invention, the communication apparatus 100A with more than one inserted subscriber identity card may handle multiple equipment identity requests from more than one camped on cell to provide a more reliable service. Typically, a communication apparatus is uniquely identified by an international mobile station equipment identity (IMEI). The IMEI may be composed of a Type Approval Code (TAC, 6 digits), a Final Assembly Code (FAC, 2 digits), a Serial Number (SNR, 6 digits) and a spare digit. The FAC identifies the manufacturing/final assembly location. The SNR uniquely identifies the communication apparatus 100A within each TAC and FAC. The spare digit may be zero, when transmitted by the communication apparatus 100A. Because the communication apparatus 100A is equipped with a single radio transceiver module 104 and baseband module 103 as shown in FIG. 1, the baseband module 103 may store two IMEIs in the memory device 106 for two subscriber identity cards respectively inserted into two sockets (e.g. sockets 303 and 304). Assuming that the subscriber identity cards are respectively inserted into sockets A and B (e.g. 303 and 304), then IMEI A and IMEI B corresponding to sockets A and B may be respectively provided when manufacturing the communication apparatus 100A and may be stored in a non-volatile region of the memory device. FIG. 15 shows a flow chart of providing the IMEIs when manufacturing the communication apparatus 100A according to an embodiment of the invention. First, a first equipment identity is provided for the first socket (Step S1501). Next, a second equipment identity is provided for the second socket (Step S1502). Finally, the first equipment identity and the second equipment identity are stored in a non-volatile region of the memory device (Step S1503).

There are various procedures to be used for mobility management for General Packet Radio Service (GPRS) services and for non-GPRS services at the radio interface. The main function of the Mobility Management (MM) sub-layer is to support the mobility of communication apparatus 100A, such as informing the wireless network of its present location and providing user identity confidentiality. The MM sub-layer further provides connection management services to the different entities of the upper Connection Management (CM) sub-layer. Two sets of procedures may be defined for MM procedure: MM procedures for non-GPRS services; and GMM procedures for GPRS services. Meanwhile, three types of MM procedures are provided: MM common procedures, MM specific procedures and MM connection management procedures, wherein initiation is dependent upon circumstances. An MM common procedure may be initiated whilst an RR connection exists. An MM specific procedure may be initiated if no other MM specific procedure is running or no MM connection exists. An MM connection management procedure is used to establish, maintain and release an MM connection between the communication apparatus and the wireless network. Meanwhile, an entity of the upper CM layer may exchange information with its peer. Two types of GMM procedures: GMM common procedures and GMM specific procedures are provided. A GMM common procedure can always be initiated whilst a packet switch signaling connection exists. A GMM specific procedure is initiated by the wireless network and used by the IMSI in the wireless network for GPRS services and/or non-GPRS services and to release a GMM context.

Because the communication apparatus 100A is equipped with only one radio transceiver module 104 and baseband module 103 but carrying two subscriber identity cards as shown in FIG. 1, the communication apparatus 100A may camp on two cells with respectively two IMSI stored in the inserted subscriber identity cards 101 and 102. FIG. 16 shows a sequence diagram illustrating an identification procedure according to the embodiment of the invention. In either the MM common procedures or MM specific procedures, the identification procedure as shown in FIG. 16 may be used by the wireless network to request a communication apparatus 100A to provide specific identification parameters to the wireless network, such as an IMSI or an IMEI. The identification procedure may be triggered during location update or other circumstances. The wireless network initiates the identification procedure by transferring an IDENTITY REQUEST message to the communication apparatus 100A. The IDENTITY REQUEST message specifies the requested identification parameters in the identity type information element, wherein the identity type may be an IMSI or IMEI. Upon the reception of the IDENTITY REQUEST message with the identity type set as an IMEI, the communication apparatus 100A sends back an IDENTITY RESPONSE with one IMEI. Sometimes, two subscriber identity cards (e.g. 101 and 102) may camp on different cells of the same network operator, and unexpected situations may occur when responding with the same IMEI to different cells. Specifically, the network operator may determine that the communication apparatus 100A is in an abnormal situation and block the communication with the communication apparatus 100A when discovering that more than two IMSI are associated with the same IMEI in a predetermined time interval via the mentioned identification procedure.

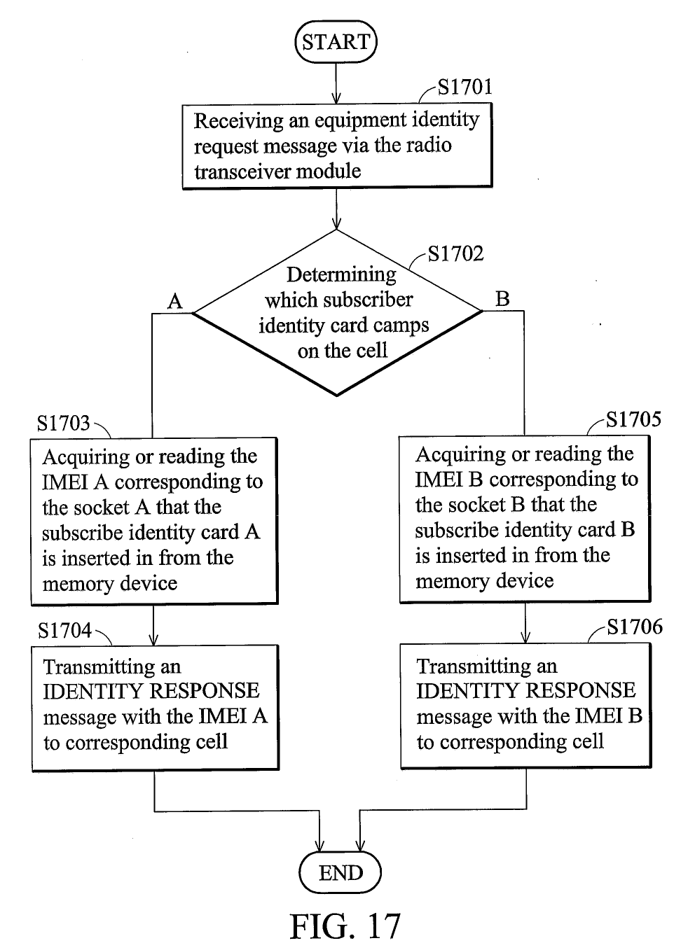

FIG. 17 shows a flow chart of the method for handling the equipment identity requests in the identification procedure according to an embodiment of the invention. First, the processor (e.g. 105) receives an equipment identity request message from a cell belonging to a wireless network via the radio transceiver module (Step 1701), wherein the equipment identity request message may be the IDENTITY REQUEST message with the identity type set as an IMEI as previously described. Next, the processor determines which cell has sent the equipment identity request message and which subscriber identity card camps on the cell (Step 1702). When the processor determines the subscribe identity card A (e.g. the subscribe identity card 101) camps on the cell sending out the IDENTITY REQUEST message, the processor acquires or reads out the IMEI A corresponding to the socket A that the subscribe identity card A is inserted into from the memory device (Step 1703) and transmits an IDENTITY RESPONSE message with the IMEI A to the corresponding cell of the wireless network via the radio transceiver module (Step 1704). When the processor determines the subscribe identity card B (e.g. the subscribe identity card 102) camps on the cell sending out the IDENTITY REQUEST message, the processor acquires or reads out the IMEI B corresponding to the socket B that the subscribe identity card B is inserted into from the memory device (Step 1705) and transmits an IDENTITY RESPONSE message with the IMEI B to the corresponding cell of the wireless network via the radio transceiver module (Step 1706).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communication apparatus, comprising:
at least one radio transceiver module;
a first subscriber identity card camping on a first cell belonging to a first wireless network via the radio transceiver module;
a second subscriber identity card camping on a second cell belonging to a second wireless network via the radio transceiver module;
a memory device storing a plurality of phonebook entries each comprising a destination address and information indicating one of the first and second subscriber identity cards as a preferred subscriber identity card for the destination address; and
a processor coupled to the first subscriber identity card, the second subscriber identity card, the memory device and the radio transceiver module, receiving an apparatus originated communication request with a first destination address, determining a preferred subscriber identity card for the received first destination address by inspecting the phonebook entries, and establishing a wireless communication with a peer device with the received first destination address through one of the first cell and the second cells in response to the determined preferred subscriber identity card.

2. The communication apparatus as claimed in claim 1, wherein the processor further receives an apparatus originated communication request with a second destination address, obtains information regarding one of the first subscriber identity card and the second subscriber identity card to be utilized for the received second destination address via a man-machine interface (MMI) when no preferred subscribed identity card for the received second destination address is found in the phonebook entries, and establishes a wireless communication with a peer device with the received and unfounded second destination address through one of the first cell and the second cells according to the obtained information.

3. The communication apparatus as claimed in claim 2, wherein the processor further stores a new phonebook entry comprising the second destination address and information indicating one of the first and second subscriber identity cards as a preferred subscriber identity card for the second destination address according to the obtained information via the MMI.

4. The communication apparatus as claimed in claim 1, wherein each phonebook entry further comprises information indicating one of a first bearer and a second bearer as a preferred bearer for a destination address, and wherein the processor further determines a preferred bearer for the received first destination address by inspecting the phonebook entries, and establishes the wireless communication with a peer device with the received first destination address through the preferred bearer.

5. The communication apparatus as claimed in claim 4, wherein the processor further receives an apparatus originated communication request with a second destination address, obtains information regarding one of the first bearer and the second bearer to be utilized for the received second destination address via a man-machine interface (MMI) when no preferred bearer for the received second destination address is found in the phonebook entries, and establishes the wireless communication with a peer device with the received and unfounded second destination address through one of the first bearer and the second bearer according to the obtained information.

6. The communication apparatus as claimed in claim 5, wherein the processor further stores a new phonebook entry comprising the second destination address and information indicating one of the first and second bearers as a preferred bearer for the second destination address according to the obtained information via the MMI.

7. The communication apparatus as claimed in claim 4, wherein the bearer is a voice call, a data call, a video call or a voice over Internet Protocol (VOIP) call.

8. The communication apparatus as claimed in claim 1, wherein at least one of the first subscriber identity card and the second subscriber identity card is the subscriber identity module (SIM) card corresponding to the global system for mobile communications (GSM), the universal subscriber identity module (USIM) card corresponding to the universal mobile telecommunications system (UMTS), or the removable user identity module (RUIM) card or the CDMA subscriber identity module (CSIM) card corresponding to the code division multiple access (CDMA) 2000 communication system.

9. The communication apparatus as claimed in claim 1, wherein the memory device further stores at least one identity each corresponding to a subscriber identity card has or had been inserted therein, and wherein the processor further detects whether the subscriber identity card corresponding to the identity of the memory device is replaced with at least one of the first and second subscriber identity cards by comparing the identity of the memory device with an identity corresponding to the first subscriber identity card and an identity corresponding to the second subscriber identity card, and when detecting the replacement, the processor updates at least one of the identities stored in the phonebook entries corresponding to the subscriber identity card being removed with the identity corresponding to the first or second subscriber identity card newly inserted.

10. The communication apparatus as claimed in claim 9, wherein the identity corresponding to a subscriber identity card is the international mobile subscriber identity (IMSI).

11. The communication apparatus as claimed in claim 9, wherein the identity corresponding to a subscriber identity card has or had been inserted therein is stored in a non-volatile region of the memory device.

12. A method for processing an apparatus originated communication request of a communication apparatus, wherein the communication apparatus comprises at least one radio transceiver module, a first subscriber identity card camping on a first cell belonging to a first wireless network via the radio transceiver module, a second subscriber identity card camping on a second cell belonging to a second wireless network via the radio transceiver module, a memory device storing a plurality of phonebook entries each comprising an address and information indicating one of the first and second subscriber identity cards as a preferred subscriber identity card for the address, and at least one processor coupled to the first subscriber identity card, the second subscriber identity card, the memory device and the radio transceiver module for controlling the operation thereof, the method comprising:
receiving an apparatus originated communication request with a destination address;
determining whether an identity of the preferred subscriber identity card for the received destination address has been stored in one of the phonebook entries; and
establishing a wireless communication with a peer device with the received destination address through one of the first or second cell that the preferred subscriber identity card camps on when the identity of the preferred subscriber identity card for the received destination address has been stored.

13. The method as claimed in claim 12, further comprising:
obtaining information regarding one of the first subscriber identity card and the second subscriber identity card to be utilized for the received destination address via a man-machine interface (MMI) when the identity of the preferred subscriber identity card for the received destination address has not been stored; and
establishing the wireless communication with the peer device with the received destination address through one of the first cell and the second cells according to the obtained information.

14. The method as claimed in claim 13, further comprising:
storing a new phonebook entry comprising the received destination address and information indicating one of the first and second subscriber identity cards as the preferred subscriber identity card for the received destination address according to the obtained information via the MMI.

15. The method as claimed in claim 12, wherein each phonebook entry further comprises information indicating one of a first alternative line service (ALS) and a second ALS as a preferred ALS for the corresponding address, and the method further comprises:
determining whether the preferred ALS for the received destination address has been stored in one of the phonebook entries; and
establishing the wireless communication with the peer device with the received destination address through the preferred ALS when the preferred ALS for the received destination address has been stored.

16. The method as claimed in claim 15, further comprising:
obtaining information regarding one of the first ALS and the second ALS to be utilized for the received destination address via a man-machine interface (MMI) when the preferred alternative line service has not been stored; and
establishing the wireless communication with the peer device with the received destination address through one of the first ALS and the second ALS according to the obtained information.

17. The method as claimed in claim 16, further comprising:
storing a new phonebook entry comprising the received destination address and information indicating one of the first ALS and the second ALS as a preferred ALS for the received destination address according to the obtained information via the MMI.

18. The method as claimed in claim 12, wherein the phonebook entries are stored in a non-volatile region of the memory device.

19. A communication apparatus, comprising:
a single radio transceiver module;
a first socket corresponding to a first equipment identity;
a second socket corresponding to a second equipment identity;
a first subscriber identity card inserted into the first socket and camping on a first cell belonging to a first wireless network via the radio transceiver module;
a second subscriber identity card inserted into the second socket and camping on a second cell belonging to a second wireless network via the radio transceiver module;
a memory device storing the first equipment identity and the second equipment identity; and
a processor coupled to the first subscriber identity card, the second subscriber identity card, the memory device and the radio transceiver module, receiving an equipment identity request message via the radio transceiver module, determining whether the equipment identity request message is sent from the first cell or the second cell, responding with the first equipment identity via the radio transceiver module when the equipment identity request message is sent from the first cell, and responding with the second equipment identity via the radio transceiver module when the equipment identity request message is sent from the second cell.

20. The communication apparatus as claimed in claim 19, wherein each of the first equipment identity and the second equipment identity is the international mobile station equipment identity (IMEI).

21. The communication apparatus as claimed in claim 19, wherein the equipment identity request message with an identity type of the international mobile station equipment identity (IMEI) is sent during a mobility management common procedure or a mobility management specific procedure.

22. The communication apparatus as claimed in claim 19, wherein at least one of the first subscriber identity card and the second subscriber identity card is the subscriber identity module (SIM) card corresponding to the global system for mobile communications (GSM), the universal subscriber identity module (USIM) card corresponding to the universal mobile telecommunications system (UMTS), or the removable user identity module (RUIM) card or the CDMA subscriber identity module (CSIM) card corresponding to the code division multiple access (CDMA) 2000 communication system.

23. The communication apparatus as claimed in claim 19, wherein information regarding the first socket corresponding to the first equipment identity and the second socket corresponding to the second equipment identity is stored in a non-volatile region of the memory device.
